(19) United States
(12) Patent Application Publication
(10) Pub. No.: US 2013/0086831 A1
(43) Pub. Date: Apr. 11, 2013

(54) PHONOGRAPH GREETING CARD

(71) Applicant: American Greetings Corporation, Cleveland, OH (US)

(72) Inventors: David MAYER, Bay Village, OH (US); April NEMETH, Westlake, OH (US); Gary NELSON, Avon, OH (US); Allison MARSH, Westlake, OH (US); Katalina SPECK, Rocky River, OH (US); Dave SAPP, Avon Lake, OH (US)

(73) Assignee: American Greetings Corporation, Cleveland, OH (US)

(21) Appl. No.: 13/654,659

(22) Filed: Oct. 18, 2012

Related U.S. Application Data
(63) Continuation-in-part of application No. 13/270,611, filed on Oct. 11, 2011.
(60) Provisional application No. 61/548,421, filed on Oct. 18, 2011.

(51) Int. Cl. G09F 1/08

(52) U.S. Cl. CPC G09F 1/08
USPC 40/124.03

(57) ABSTRACT

The greeting card of the present invention combines paper, mechanical and electrical components to simulate the action of a record player or phonograph. When the greeting card is opened, a paper record begins to spin as audio plays along in the background. The greeting card is made of heavy-gauge paperboard formed into a box-like structure with a flap opening thereon. The box-like structure or body of the greeting card may have various indicia printed thereon which make the greeting card resemble a mini record player or phonograph. The box-like structure contains a cavity therein which houses and conceals the mechanical and electrical components of a greeting card. A corrugate insert, also located within the cavity, serves as protection for the mechanical components.

### RELATED APPLICATIONS

This application claims priority to U.S. Provisional Patent Application Ser. No. 61/548,421, filed on Oct. 18, 2011. This application is a continuation-in-part of and claims priority to U.S. patent application Ser. No. 13/270,611, filed on Oct. 11, 2011. Each of the above-referenced patent applications is incorporated herein by reference in its entirety.

### FIELD OF THE INVENTION

The present invention is in the field of social expression and entertainment products, and more specifically to greeting cards having mechanical functions and features.

### BACKGROUND OF THE INVENTION

Traditional paper greeting cards have been widely used for celebratory occasions such as birthdays, graduations, weddings, and for other commercial purposes. More recently, the market has expanded with greeting cards that attempt to capture attention by alternate designs and other features to enhance the communicative and entertainment value of social and relational greetings. The widespread availability of compact digital electronics has made incorporation into social communication products economical.

### SUMMARY OF THE INVENTION

The greeting card of the present invention combines paper and mechanical and electronic components to mimic the action and sound of a record player or phonograph. When the greeting card is opened, a paper “record” begins to spin as audio plays along in the back ground. The greeting card is made of heavy gauge paperboard formed into a box-like structure with a flap opening thereon. The box-like structure or body of the greeting card may have various indicia printed thereon which make the greeting card resemble a mini record player or phonograph. The box-like structure contains a cavity therein which houses and conceals the mechanical and electrical components of the greeting card. A corrugate insert, also located within the cavity, serves as protection for the mechanical components.

### DESCRIPTION OF THE DRAWINGS

FIG. 1 is a perspective view of the greeting card of the present invention, in an opened position.

FIG. 2 is a perspective view of the greeting card of FIG. 1, in a closed position.

FIG. 3 is an exploded view of the greeting card of FIG. 1.

### DETAILED DESCRIPTION OF PREFERRED AND ALTERNATE EMBODIMENTS

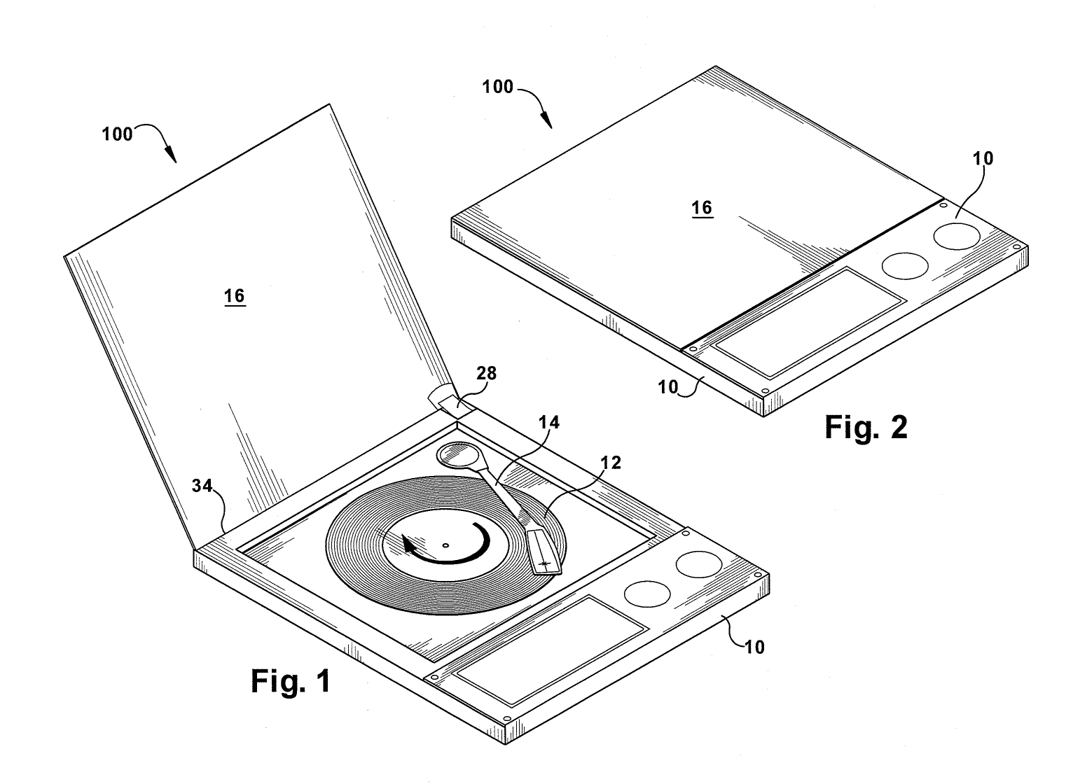

The greeting card of the present invention combines paper and mechanical and electronic components to mimic the appearance, action and sound of a record player or phonograph, as shown in FIGS. 1 and 2. When the greeting card 100 is opened, a paper “record” 12 begins to spin as audio plays along in the back ground. The greeting card 100 is made of heavy gauge paperboard formed into a box-like structure 10 with a flap opening 16 thereon. The box-like structure or body of the greeting card 10 may have various indicia printed thereon which make the greeting card 100 resemble a mini record player or phonograph. The box-like structure 10 contains a cavity therein which houses and conceals the mechanical and electrical components of the greeting card. A corrugate insert 18, also located within the cavity, serves as protection for the mechanical components.

The greeting card 100 is in the form of a generally box-like structure which serves as the greeting card body 10. The structure includes one or more layers of corrugate, cardboard, or other similar material having various cutouts or sunken portions which accommodate placement of the mechanical and electronic components of the greeting card therein. The protective insert 18 substantially surrounds each mechanical and electronic component, thereby protecting the internal components from damage. The protective insert 18 may include one or more distinct layers of corrugate placed atop one another or the insert 18 may be a single contiguous piece of corrugate which is folded in such a way that it creates a layered configuration, adding height or increasing the elevation of the corrugate structure. The protective insert 18 may alternatively be constructed with various sized individual corrugate pieces which are attached, adhesively or otherwise, to form the substantially square or rectangular configuration of the greeting card 100. Other materials such as plastic and foam may alternatively be used instead of or in addition to the corrugate or cardboard material. In a preferred embodiment, the perimeter edges of the corrugate structure have the same height, thickness or elevation. This allows the greeting card 100 to have a substantially planar outer surface with the various mechanical and electronic components contained and protected therein. In a preferred embodiment, a significant portion of the protective insert 18 contains a sunken in portion or cutout which is at a lower elevation than the perimeter edges and the remaining portion of the structure. This cutout portion contains openings thereon for the placement of one or more mechanical or electrical components, such as, for example, a speaker 20, a motor 22, a power source such as one or more batteries 26 and various wires which connect the various components to a circuit board 24. The openings in the cutout portion of the protective insert 18 may be shaped like the components such as a circular opening for the circular speaker, etc.

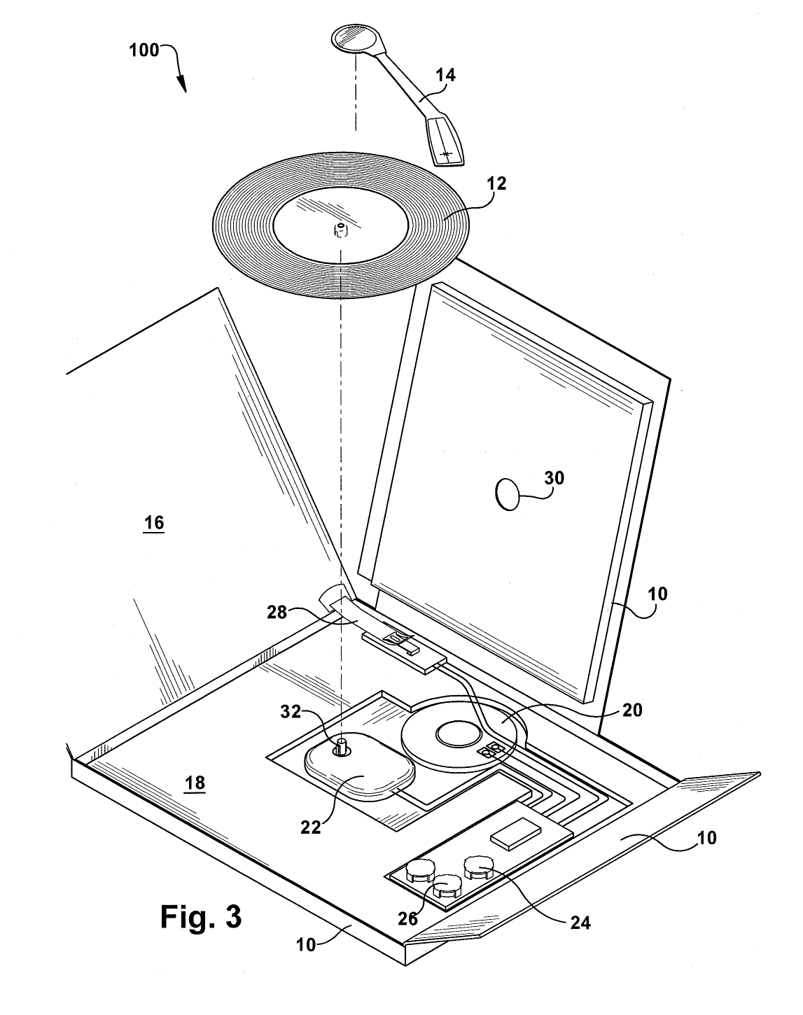

Each of the various mechanical or electronic components may be attached, adhesively or otherwise, to the protective insert 18 or to a separate substrate, or directly onto the outer greeting card cover. A switch 28 may be contained within an opening or cutout in one of the perimeter edges of the protective insert 18 or anywhere within or attached to the greeting card body 10. The switch 28 may be a slide switch, as shown in FIGS. 1 and 3, having a tongue mechanism which is attached to a flap opening 16 in the front of the greeting card structure 10 so that when the flap 16 is opened, the switch 28 activates the motor 22 and sound modules. Other types of switches may be used in place of a slide switch, such as a magnetic switch, a press-button switch, a light-sensitive switch, a touch-sensitive switch, or any other switch mechanism. The various mechanical and electronic components, such as the motor 22 and sound modules may include, but are not limited to, a circuit board 24, an integrated circuit chip, a memory or digital storage device, a power source such as one or more batteries 26, a speaker 20, a motor 22, a switch 28, and any other component, familiar to one of skill in the art that is required or that facilitates the storage and playback of digital audio, the movement of a motor and other components connected thereto, the activation of one or more lights, or any other such special effects.

The greeting card 100 contains a multi-panel greeting card body 10 and various die cut paper components. The multi-panel greeting card body 10 may be made of paper, paperboard, cardboard, or any other such material having a plurality of panels connected along a plurality of fold lines. The greeting card body 10 encases and conceals the protective insert 18 and the mechanical and electronic components of the greeting card. The body 10 serves as an outer surface of the greeting card 100. It may contain artwork, photographs, drawings, text and/or other paper finishings which create the illusion of an old-fashioned phonograph or record player. Such artwork or printing may include on/off and volume dials or buttons, a speaker and turntable. The greeting card may also contain text sentiment on one or more panels of the cover. Additional die cut paper components include a flap or movable panel 16 which serves as a means for opening the greeting card 100, a circular shaped die cut piece which resembles a record 12 (hereinafter “record), such as a classic vinyl 45 record, and a die cut piece resembling the arm 14 of a record player or phonograph. The multi-panel greeting card cover 10 may contain one or more openings 30 thereon through which the record 12 is connected to the motor 22. The record 12 may be connected directly to the motor 22 or may be attached to an attachment arm 32 extending outward from the motor 22. The motor 22 may be of the type having a rotating gear mechanism that when activated, turns a circular gear. The circular die cut piece or record 12 is connected either directly or indirectly to the circular gear and therefore rotates upon activation of the motor 22. The die cut piece resembling the record player arm 14 is positioned such that it is slightly angled above the record 12, such that it appears that the arm 14 is attached at one end to a turntable and at the other to a needle which is in contact with the top surface of the record 12. The flap or movable panel 16 may be connected to the switch 28 so that the sound and motor modules are activated upon opening the greeting card 100 by moving the flap or movable panel 16 away from the greeting card 100. The flap or movable panel 16 may be attached to the multi-panel greeting card body 10 along a fold line 34 which corresponds to an outer perimeter edge of the greeting card 100. The flap 16 may be positioned such that it opens in an upward direction by pivoting about a horizontal fold line located at the top edge of the greeting card or it can be positioned such that it opens to the left by pivoting about a vertical fold line located along a left side edge of the greeting card. Once the greeting card 100 is opened by moving the flap or movable panel 16, the switch 28 triggers the sound module to playback a pre-recorded digital audio file stored within the sound module and also triggers the motor module to rotate or spin the record 12. This activation method imitates a record playing on a record player.

In a preferred embodiment, a pre-recorded audio file is contained within the sound module and may be a song which complements the theme or occasion of the greeting card. For example, a birthday card may contain a pre-recorded digital audio file which contains the song “Happy Birthday.” Alternatively, the record 12 may be decorated with imagery and text indicating a particular song or album, which is contained within the sound module and replayed upon opening the greeting card 100. The digital audio file may additionally contain sound effects such as static at the beginning of and/or during the song to simulate the playback of old vinyl records.

In one embodiment, the greeting card is substantially rectangular with a width of between approximately 6 and 7 inches and a length of between approximately 5 and 6 inches. In another embodiment, the width may be between approximately 10 and 12 inches wide with a length of approximately 8 and 10 inches. The thickness of the greeting card 100 is approximately 0.5 inches. However, other length, width and thickness measurements have been contemplated and are considered to be within the scope of the present invention.

In another embodiment, the greeting card may contain additional components which would provide the user or consumer with the ability to upload personally selected digital audio files to the greeting card for playback upon opening the greeting card. The user uploaded audio files may be uploaded to a memory device within the greeting card via a USB port, SD card slot, or any other device which facilitates connection to an external memory device. The USB port or SD card slot may be accessed through a side or back of the greeting card and may have a retractable cord for ease of use. The user-supplied audio file can be played when the greeting card is opened while the record spins.

In other variations, the greeting card of the present disclosure may additionally include components such as a recording module and microphone to record, store and playback a song sung by a consumer to the card recipient. A digital audio file may contain instrumental music which can be played before, after, or simultaneously (karaoke-style) with the user's recorded lyrics.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A greeting card comprising:
a sound module operative to store and playback one or more audio files;
a motor module operative to rotate a circular die cut disc which resembles a record;
a protective housing surrounding the sound and motor modules;
a multi-paneled covering surrounding and concealing the sound and motor modules and protective housing;
a flap attached to a perimeter edge of the multi-paneled covering;
a switch operative to control activation of the sound and motor modules;
a die cut piece attached to an inner surface of the greeting card, the die cut piece being proximate to the circular die cut disc and resembling a phonograph arm and needle.

2. The greeting card of claim 1, wherein the protective housing is made of corrugate or cardboard.

3. The greeting card of claim 1, wherein the protective housing comprises corrugate and foam.

4. The greeting card of claim 1, wherein the outer surface of the multi-paneled covering is designed to resemble a record player or phonograph.

5. The greeting card of claim 1, wherein the switch is attached to the flap so that the sound and motor modules are activated upon pivoting the flap away from the greeting card.

6. The greeting card of claim 1, wherein the flap is located along a top perimeter edge of the greeting card.

7. The greeting card of claim 1, wherein the flap is located along a side perimeter edge of the greeting card.

8. A greeting card comprising:
a rectangular shaped housing;
a movable panel attached along one perimeter edge of the housing;
a motor module contained and concealed within the housing;
a sound module contained and concealed within the housing;
a movable die cut piece in the shape of a circular record, attached to the motor module;
a static die cut piece in the shape of a phonograph needle arm, attached to the housing;
wherein moving the movable panel away from the greeting card causes rotational movement of the moveable die cut piece and playback of at least one audio file contained on the sound module.

9. The greeting card of claim 8 further comprising a protective insert contained within the housing which surrounds the sound and motor modules.

10. The greeting card of claim 8, wherein the at least one audio file contains music and simulated static to mimic the sound of a vinyl record.

11. The greeting card of claim 8, wherein the housing contains printing thereon which resembles an old-fashioned phonograph.

12. The greeting card of claim 8 further comprising a slide switch mechanism attached to the housing proximate to the movable flap.

13. The greeting card of claim 8, wherein the greeting card has a greater width than length.

14. The greeting card of claim 8, wherein the greeting card has a greater length than width.

15. The greeting card of claim 8, wherein the greeting card has a thickness of approximately 0.5 inches.

16. A greeting card comprising:
a three-dimensional rectangular housing resembling an old-fashioned phonograph;
a protective insert contained within the housing;
a sound module operative to store and playback at least one audio file;
a motor module operative to cause movement to one or more moveable objects;
a flap attached to the housing;
a circular movable object attached to the motor and located beneath the flap, the circular moveable object resembling a vinyl record;
a static object attached to the housing proximate to the circular moveable object beneath the flap, the static object resembling a phonograph needle arm;
a switch which activates the sound module causing playback of the at least one audio file and which also activates the motor module causing rotational movement of the circular moveable object.

17. The greeting card of claim 16, wherein the switch is a slide switch.

18. The greeting card of claim 17, wherein the switch is located proximate to the flap.

19. The greeting card of claim 16, wherein the at least one audio file contains music and simulated static to mimic playback of a vinyl record.

20. The greeting card of claim 16, wherein the flap is attached to a top or left perimeter edge of the housing.
